(19) United States
(12) Patent Application Publication
(10) Pub. No.: US 2024/0263893 A1
(43) Pub. Date: Aug. 8, 2024

(54) HEAT EXCHANGER

(71) Applicant: NGK INSULATORS, LTD., Nagoya-City (JP)

(72) Inventors: Yui HONDA KURIMOTO, Nagoya-Shi (JP); Tatsuo KAWAGUCHI, Mizuho-Shi (JP); Ryushiro AKAISHI, Nagoya-Shi (JP); Shinnosuke IWASAKI, Komaki-Shi (JP)

(73) Assignee: NGK INSULATORS, LTD., Nagoya-City (JP)

(21) Appl. No.: 18/407,526

(22) Filed: Jan. 9, 2024

(30) Foreign Application Priority Data
Feb. 7, 2023 (JP) 2023-017097

(51) Int. Cl. F28F 13/06; F28D 20/00; F28D 20/02; F28F 7/02

(52) U.S. Cl. CPC F28F 13/06; F28D 20/028; F28F 7/02; F28D 2020/0017

(57) ABSTRACT

A heat exchanger includes: a first flow path through which a first fluid can flow; and a second flow path through which a second fluid can flow, the second flow path having an annular flow path portion extending along an axial direction of the first flow path on an outer peripheral side of the first flow path. A honeycomb structure having an outer peripheral wall and partition walls disposed on an inner side of the outer peripheral wall, the partition walls defining a plurality of cells each extending from a first end face to a second end face, is housed in the first flow path. A heat storage material is retained in some of the cells of the honeycomb structure.

### CROSS REFERENCE TO RELATED APPLICATIONS

The present invention claims the benefit of priority to Japanese Patent Application No 2023-017097 filed on Feb. 7, 2023 with the Japanese Patent Office, the entire contents of which are incorporated herein by reference in its entirety.

### FIELD OF THE INVENTION

The present invention relates to a heat exchanger.

### BACKGROUND OF THE INVENTION

Recently, there is a need for improvement of fuel economy of motor vehicles. In particular, a system is expected that worms up a coolant, engine oil and an automatic transmission fluid (ATF: Automatic Transmission Fluid) at an early stage to reduce a friction loss, in order to prevent deterioration of fuel economy at the time when an engine is cold, such as when the engine is started. Further, a system is expected that heats an exhaust gas purifying catalyst in order to activate the catalyst at an early stage.

As such a system, for example, there is a heat exchanger. The heat exchanger is a device that exchanges heat between a first fluid and a second fluid by allowing the first fluid to flow inside and the second fluid to flow outside. In such a heat exchanger, for example, the heat can be effectively utilized by exchanging the heat from the first fluid having a higher temperature (for example, an exhaust gas) to the second fluid having a lower temperature (for example, cooling water).

As a heat exchanger that recovers heat from a high-temperature fluid such as an exhaust gas from an automobile, Patent Literature 1 proposes a heat exchanger (waste heat recovery device) including: a hollow honeycomb structure; and a casing for housing the hollow honeycomb structure, wherein the casing includes: a cylindrical member disposed to be fitted to an outer peripheral surface of the hollow honeycomb structure; and a casing body forming a path for a heat exchange medium on an outer side of the cylindrical member, and wherein the heat exchanger has a branched path that branches the path of the exhaust gas flowing into a hollow portion of the hollow honeycomb structure into the hollow portion and cells of the hollow honeycomb structure, and controls a flow rate of the exhaust gas flowing through the cells of the hollow honeycomb structure by changing ventilation resistance of the path of the exhaust gas in the hollow portion of the hollow honeycomb structure. The heat exchanger having such a structure can achieve downsizing, reduce pressure loss, and increase an amount of heat recovery.

The heat exchanger described in Patent Literature 1 performs the recover of heat from the exhaust gas and transmittance of the recovered heat to the heat exchange medium at approximately the same timing, which would limit the period during which the recovered heat can effectively be used. For example, when the heat is not being recovered from the exhaust gas, the transmittance of the heat to the heat exchange medium (i.e., heat exchange) cannot be performed. Also, when recovering the heat from the exhaust gas and transmitting the recovered heat to the heat exchange medium at approximately the same timing, the heat that cannot be recovered remains as waste heat. Therefore, there was also room for improvement in terms of the effective utilization of the heat.

It should be noted that, in the heat exchanger described in Patent Literature 1, it proposes to provide a heat insulating layer made of a heat storage material or the like on the outer side of the path of the heat exchange medium, but this heat insulating layer aims at suppression of dissipation of the heat from the heat exchange medium, and it cannot expand the period during which the recovered heat can effectively be used.

The present invention has been made to solve the above problems. An object of the present invention is to provide a heat exchanger that can improve an amount of heat recovered and expand the period when the recovered heat can used be effectively.

### PRIOR ART

### Patent Literature

### [Patent Literature 1] WO 2017/069265 A1

### SUMMARY OF THE INVENTION

As a result of intensive studies for heat exchangers using honeycomb structures, the present inventors have found that the above problems can be solved by retaining a heat storage material in some cells of the honeycomb structure, and completed the present invention. That is, the present invention is illustrated as follows.

[1]

A heat exchanger comprising:
a first flow path through which a first fluid can flow; and
a second flow path through which a second fluid can flow, the second flow path having an annular flow path portion extending along an axial direction of the first flow path on an outer peripheral side of the first flow path;
wherein a honeycomb structure having an outer peripheral wall and partition walls disposed on an inner side of the outer peripheral wall, the partition walls defining a plurality of cells each extending from a first end face to a second end face, is housed in the first flow path, and
wherein a heat storage material is retained in some of the cells of the honeycomb structure.
   [2]

The heat exchanger according to [1], wherein the heat storage material is filled in the cells.

[3]

The heat exchanger according to [2], wherein the cells filled with the heat storage material are plugged on the first end face side and the second end face side.

[4]

The heat exchanger according to any one of [1] to [3], wherein a ratio of the cells having the retained heat storage material to all the cells of the honeycomb structure is 10% or more.

[5]

The heat exchanger according to any one of [1] to [4], wherein the heat storage material is a latent heat storage material and/or a sensible heat storage material.

[6]

The heat exchanger according to any one of [1] to [5], wherein the honeycomb structure further comprises an inner peripheral wall, and the honeycomb structure is a hollow honeycomb structure having the partition walls between the inner peripheral wall and the outer peripheral wall.

[7]

The heat exchanger according to any one of [1] to [6],
wherein the first flow path is branched into two portions;
wherein the honeycomb structure is housed in one branched first flow path, and the second flow path is provided on an outer peripheral side of the one branched first flow path,
wherein the heat exchanger further comprises a valve capable of switching the flow of the first fluid to the one branched first flow path or other branched first flow path.
   [8]

The heat exchanger according to [7], further comprising a control unit capable of controlling the valve to a heat recovery mode where heat recovery is performed by switching the flow of the first fluid to the one branched first flow path, and a non-heat recovery mode where heat recovery is not performed by switching the flow of the first fluid to the other branched first flow path.

[9]

The heat exchanger according to [7],
wherein the first flow path is configured to have a first circulation route through which the first fluid can flow through the cells of the honeycomb structure, and a second circulation route through which the first fluid can flow through the interior of the inner peripheral wall of the honeycomb structure,
wherein the heat exchanger further comprises a valve capable of switching the flow of the first fluid to the first circulation route or the second circulation route by controlling the flow of the first fluid in the second circulation route.
   [10]

The heat exchanger according to [7], further comprising a control unit capable of controlling the valve to a heat recovery mode where heat recovery is performed by switching the flow of the first fluid to the first circulation route; and a non-heat recovery mode where heat recovery is not performed by switching the flow of the first fluid to the second circulation route.

### BRIEF DESCRIPTION OF THE DRAWINGS

FIG. 1A is a cross-sectional view of a heat exchanger according to Embodiment 1 of the present invention, which is parallel to a flow direction of a first fluid;

FIG. 1B is a cross-sectional view taken along the line a-a′ in the heat exchanger of FIG. 1A;

FIG. 2 is a cross-sectional view of a honeycomb structure used in a heat exchanger according to Embodiment 1 of the present invention, which is perpendicular to an extending direction of cells;

FIG. 3 is a cross-sectional view of another heat exchanger according to Embodiment 1 of the present invention, which is parallel to a flow direction of a first fluid;

FIG. 4A is a cross-sectional view of a heat exchanger according to Embodiment 2 according to the present invention, which is parallel to a flow direction of a first fluid; and

FIG. 4B is a cross-sectional view taken along the line b-b′ in the heat exchanger of FIG. 4A.

### DETAILED DESCRIPTION OF THE INVENTION

The present invention relates to a heat exchanger including: a first flow path through which a first fluid can flow; a second flow path through which a second fluid can flow, the second flow path having an annular flow path portion extending along an axial direction of the first flow path on an outer peripheral side of the first flow path; wherein a honeycomb structure having an outer peripheral wall and a partition wall disposed on an inner side of the outer peripheral wall, the partition wall defining a plurality of cells each extending from a first end face to a second end face, is housed in the first flow path, and wherein a heat storage material is retained in some of the cells of the honeycomb structure. The heat exchanger having such a structure can recover and store heat from the first fluid using the heat storage material retained in the cells, so that even if the heat is not being recovered from the first fluid, the heat exchanger can perform the transmission of the heat to the second fluid (i.e., heat exchange). Therefore, it is possible to expand the period during which the recovered heat can effectively be used. Further, when the heat is recovered from the first fluid, the recovery of the heat from the first fluid and the transmission of the recovered heat to the second fluid are performed at approximately the same timing, and the heat that cannot be recovered at this timing is stored in the heat storage material, so that an amount of heat recovered can be improved. Therefore, waste heat can be used more effectively than conventional heat exchangers, leading to energy savings.

Hereinafter, embodiments of the heat exchanger according to the present invention will be specifically described with reference to the drawings. It is to understand that the present invention is not limited to the following embodiments, and those which appropriately added changes, improvements and the like to the following embodiments based on knowledge of a person skilled in the art without departing from the spirit of the present invention fall within the scope of the present invention.

### Embodiment 1

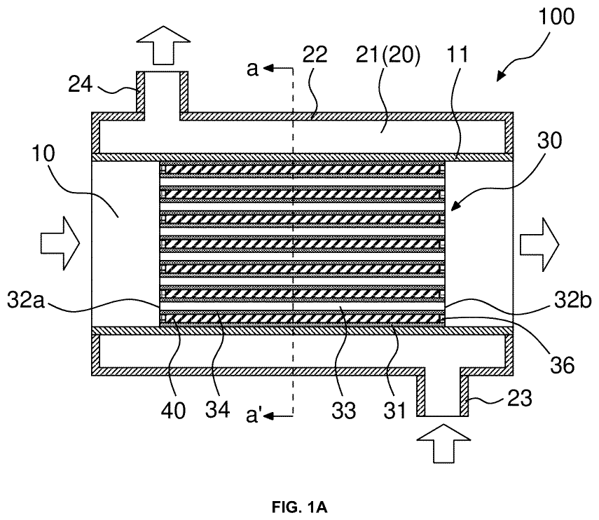

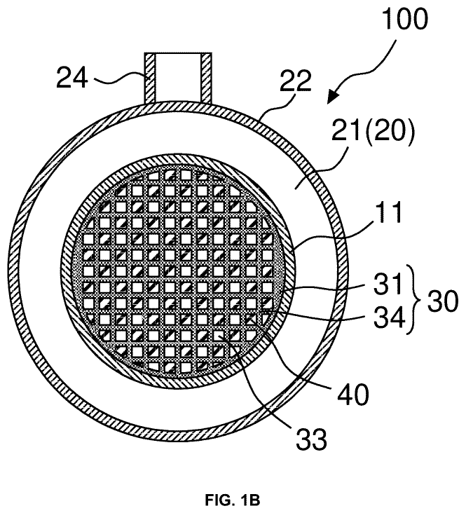

FIG. 1A is a cross-sectional view of a heat exchanger according to Embodiment 1 of the present invention, which is parallel to a flow direction of a first fluid. FIG. 1B is a cross-sectional view taken along the line a-a′ in the heat exchanger of FIG. 1A.

As shown in FIGS. 1A and 1B, a heat exchanger 100 according to Embodiment 1 of the present invention has a first flow path 10 through which a first fluid can flow, and a second flow path 20 through which a second fluid can flow, the second flow path 20 having an annular flow path portion 21 extending along an axial direction of the first flow path 10 on an outer peripheral side of the first flow path 10. A honeycomb structure 30 is housed in the first flow path 10.

### <First Flow Path>

The first flow path 10 is not particularly limited as long as it has a structure that allows the first fluid to flow therethrough and can house the honeycomb structure 30. For example, the first flow path 10 can be made using a first cylindrical member 11, as shown in FIG. 1A.

The first cylindrical member 11 is fitted, for example, to an outer peripheral surface (a surface of an outer peripheral wall 31) of the honeycomb structure 30 parallel to a flow direction of the first fluid.

As used herein, the “fitted” means that the honeycomb structure 30 and an object member (a first cylindrical member 11) are fixed in a state of being suited to each other. Therefore, the fitting of the honeycomb structure 30 and the first cylindrical member 11 encompasses cases where the honeycomb structure 30 and the first cylindrical member 11 are fixed to each other by a fixing method based on fitting such as clearance fitting, interference fitting and shrinkage fitting, as well as by brazing, welding, diffusion bonding, or the like.

The shape of the first cylindrical member 11 may be appropriately selected depending on the shape of the honeycomb structure 30 to be housed, and may have various shapes such as a cylindrical shape and a rectangular cylindrical shape.

It is preferable that an axial direction of the first cylindrical member 11 coincides with that of the honeycomb structure 30, and a central axis of the first cylindrical member 11 coincides with that of the honeycomb structure 30. Further, the diameter (an outer diameter and an inner diameter) of the first cylindrical member 11 may be uniform in the axial direction, but the diameter of at least part (for example, both end portions in the axial direction or the like) of the first cylindrical member 11 may be decreased or increased.

It should be noted that when the first cylindrical member 11 is not cylindrical, the outer diameter and inner diameter of the first cylindrical member 11 mean the diameters of the maximum circles that are circumscribed and inscribed in the cross-sectional shape of the first cylindrical member 11 perpendicular to the flow direction of the first fluid.

The first cylindrical member 11 may preferably have an inner peripheral surface shape corresponding to the outer peripheral surface of the honeycomb structure 30 parallel to the flow direction of the first fluid. Since the inner peripheral surface of the first cylindrical member 11 is in direct contact with the surface of the outer peripheral surface of the honeycomb structure 30 parallel to the flow direction of the first fluid, the thermal conductivity is improved and the heat in the honeycomb structure 30 can be efficiently transmitted to the first cylindrical member 11.

The first cylindrical member 11 is preferably made of a metal in terms of manufacturability, although not particularly limited thereto. Further, the metallic first cylindrical member 11 is also advantageous in that it can be easily welded to other member. Examples of the material of the first cylindrical member 11 that can be used herein include stainless steel, titanium alloys, copper alloys, aluminum alloys, brass and the like. Among them, the stainless steel is preferable because it has high durability and reliability and is inexpensive.

The first cylindrical member 11 preferably has a thickness of 0.1 mm or more, and more preferably 0.3 mm or more, and still more preferably 0.5 mm or more, although not particularly limited thereto. The thickness of the first cylindrical member 11 of 0.1 mm or more can ensure durability and reliability. The thickness of the first cylindrical member 11 is preferably 10 mm or less, and more preferably 5 mm or less, and still more preferably 3 mm or less. The thickness of the first cylindrical member 11 of 10 mm or less can reduce thermal resistance and improve thermal conductivity.

The honeycomb structure 30 including: the outer peripheral wall 31; and the partition walls 34 disposed on an inner side of the outer peripheral wall 31, the partition walls 34 defining the plurality of cells 33 each extending from the first end face 32a to the second end face 32b.

The shape (outer shape) of the honeycomb structure 30 may be set as needed depending on the shape of the first cylindrical member 11, and it is not particularly limited. Examples of the shape (outer shape) of the honeycomb structure 30 include a cylindrical shape, an elliptic pillar shape, a quadrangular pillar shape or other polygonal pillar shapes.

The shape of each cell 33 is not particularly limited, but it may be circular, oval, triangular, quadrilateral, hexagonal, or other polygonal in a cross section perpendicular to the extending direction of the cells 33.

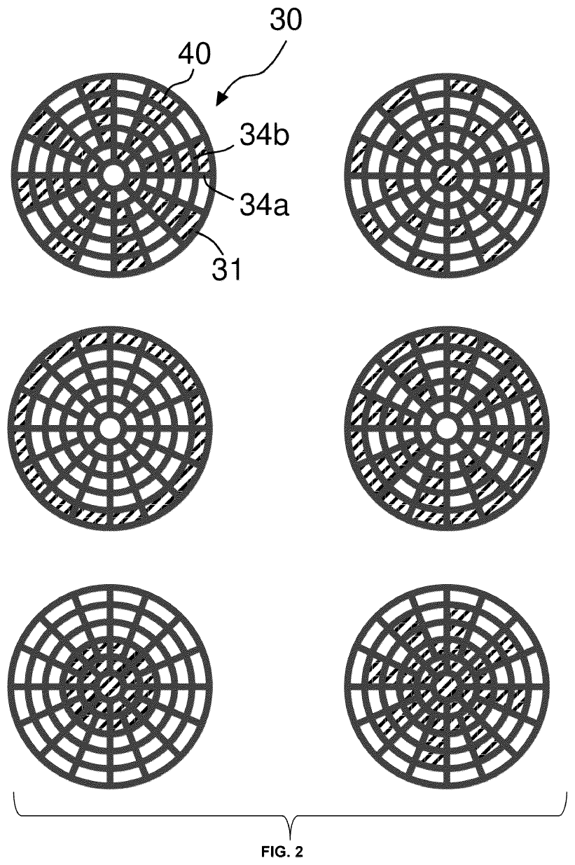

The partition walls 34 include first partition walls 34a extending in the radial direction (diameter direction) and second partition walls 34b extending in the circumferential direction, as shown in FIG. 2, in a cross section perpendicular to the extending direction of the cells 33. Such a structure allows the heat of the first fluid flowing through the cells 33 to be efficiently transferred to the second fluid flowing outside the honeycomb structure 30. It should be noted that FIG. 2 is a cross sectional view of the honeycomb structure 30 used in the heat exchanger 100 according to Embodiment 1 of the present invention, which is perpendicular to the extending direction of the cells 33.

The thickness of the outer peripheral wall 31 is preferably greater than the thickness of the partition walls 34. Such a structure allows the strength of the outer peripheral wall 31, which is susceptible to destruction (e.g., cracking, breakage, etc.) due to external impacts, thermal stress due to a temperature difference between the first fluid and the second fluid, and the like, to be increased.

The thickness of the outer peripheral wall 31 is preferably more than 0.3 mm and less than or equal to 10 mm, and more preferably 0.5 mm to 5 mm, and even more preferably 1 mm to 3 mm.

The thickness of each partition wall 12 may preferably be 0.1 mm to 1 mm, and more preferably from 0.2 mm to 0.6 mm. The thickness of the partition wall 12 of 0.1 mm or more can provide the honeycomb structure 30 with a sufficient mechanical strength. Further, the thickness of the partition wall 34 of 1 mm or less can prevent problems that the pressure loss is increased due to a decrease in an opening area and the heat recovery efficiency is decreased due to a decrease in a contact area with the first fluid.

The outer peripheral wall 31 and the partition walls 34 are based on ceramics.

As used herein, the phrase “ based on ceramics” means that a ratio of a mass of ceramics to the total mass is 50% by mass or more.

Each of the outer peripheral wall 31 and the partition walls 34 preferably has a porosity of 10% or less, and more preferably 5% or less, and even more preferably 3% or less, although not particularly limited thereto. Further, the porosity of them may be 0%. The porosity of them of 10% or less can lead to improved thermal conductivity.

The outer peripheral wall 31 and the partition walls 34 are preferably based on SiC (silicon carbide) having high thermal conductivity. Since SiC also has excellent high temperature resistance and chemical resistance, the heat exchanger 100 can be used in strict environments such as engines and plants.

As used herein, the phrase “based on SiC (silicon carbide)” means that a ratio of a mass of SiC (silicon carbide) to the total mass is 50% by mass or more.

More particularly, the material of each of the outer peripheral wall 31 and the partition walls 34 that can be used herein includes Si-impregnated SiC, (Si+Al) impregnated SiC, metal composite SiC, recrystallized SiC, Si₃N₄, SiC, and the like. Among them, Si-impregnated SiC and (Si+Al) impregnated SiC can preferably be used.

A cell density (that is, the number of cells 33 per unit area) in the cross section of the honeycomb structure 30 perpendicular to the flow path direction for the first fluid is not particularly limited, and it may be adjusted as needed, and preferably in a range of from 4 to 320 cells/cm². The cell density of 4 cells/cm² or more can sufficiently ensure the strength of the partition walls 34, hence the strength of the honeycomb structure 30 itself and effective GSA (geometrical surface area). Further, the cell density of 320 cells/cm² or less can allow an increase in a pressure loss to be suppressed when the first fluid flows.

The honeycomb structure 30 preferably has an isostatic strength of more than 100 MPa, and more preferably 150 MPa or more, and more preferably 200 MPa or more, although not particularly limited thereto. The isostatic strength of the honeycomb structure 30 of more than 100 MPa can lead to the honeycomb structure 30 having improved durability. The isostatic strength of the honeycomb structure 30 can be measured according to the method for measuring isostatic fracture strength as defied in the JASO standard M 505-87 which is a motor vehicle standard issued by Society of Automotive Engineers of Japan, Inc.

A diameter (outer diameter) of the outer peripheral wall 31 in the cross section orthogonal to the flow path direction for the first fluid may preferably be from 20 to 200 mm, and more preferably from 30 to 100 mm. Such a diameter can allow improvement of heat recovery efficiency. If the cross-sectional shape of the outer peripheral wall 31 is not circular, the diameter of the largest circle circumscribed in the cross-sectional shape of the outer peripheral wall 31 is defined as the diameter of the outer peripheral wall 31.

The honeycomb structure 30 preferably has a thermal conductivity of 50 W/(m·K) or more at 25° C., and more preferably from 100 to 300 W/(m·K), and even more preferably from 120 to 300 W/(m·K). The thermal conductivity of the honeycomb structure 30 in such a range can lead to an improved thermal conductivity and can allow the heat inside the honeycomb structure 30 to be efficiently transmitted to the outside. It should be noted that the value of thermal conductivity is a value measured according to the laser flash method (JIS R 1611-1997).

A heat storage material 40 is retained in some cells 33 of the honeycomb structure 30.

The method of retaining the heat storage material 40 in the cells 33 is not particularly limited, and various methods may be used. For example, the heat storage material 40 may be applied and fixed to the partition walls 34 that define the cells 33, or the heat storage material 40 may be filled in the cells 33 as shown in FIGS. 1A and 1B. When applying and fixing the heat storage material 40 to the partition walls 34, a layer of the heat storage material 40 may be formed on the surfaces of the partition walls 34, and there may be a portion where the heat storage material 40 is not present in the central region of each cell 33. However, it is preferable that the heat storage material 40 is filled in the cells 33. By filling the heat storage material 40 in the cells 33, an amount of the heat storage material 40 retained increases, so that the stored amount of heat recovered from the first fluid can be increased. As a result, it becomes possible to further expand the period during which the recovered heat can effectively be used.

The position of the cells 33 in which the heat storage material 40 is retained in the honeycomb structure 30 is not particularly limited. For example, in the cross section perpendicular to the extending direction of the cells 33, the heat storage material 40 can be evenly retained in all the cells 33 of the honeycomb structure 30, as shown in FIGS. 1A and 1B. Further, in the cross section perpendicular to the extending direction of the cells 33, the heat storage material 40 may be approximately evenly retained on the center side and the outer peripheral side of the honeycomb structure 30 (upper view in FIG. 2), or the heat storage material 40 may be mainly retained on the outer peripheral side (middle view in FIG. 2), or the heat storage material 40 may be mainly retained on the center side of the honeycomb structure 30 (lower view in FIG. 2).

The cells 33 filled with the heat storage material 40 are preferably plugged on the first end face 32a side and the second end face 32b side. That is, the cells 33 filled with the heat storage material 40 preferably have plugged portions 36 at the end portions on the first end face 32a side and the second end face 32b side, as shown in FIGS. 1A and 1B. Such a structure allows the heat storage material 40 to be prevented from falling off from the cells 33.

The material for the plugged portions 36 is not particularly limited, and the same material as the outer peripheral wall 31 and the partition walls 34 can be used. Alternatively, a resin sheet or the like may be used. The method for forming the plugged portions 36 is not particularly limited, and it can be performed according to a known method in the art.

A ratio of the cells 33 having the retained heat storage material 40 to all the cells 33 of the honeycomb structure 30 is not particularly limited, but a higher ratio leads to higher heat storage performance. The ratio is preferably 10% or more, and more preferably 30% or more, and still more preferably 50% or more, and particularly preferably 80% or more. However, if the ratio is too high, the pressure loss when the first fluid passes through the honeycomb structure 30 will increase. Therefore, the ratio is preferably 90% or less.

The heat storage material 40 is not particularly limited, and any material known in the art can be used. Examples of the heat storage material 40 that can be used herein include a latent heat storage material and/or a sensible heat storage material.

As used herein, the term “latent heat storage material” means a heat storage material that stores heat by utilizing latent heat accompanying a phase change between solid and liquid, and the term “sensible heat storage material” means a heat storage material that stores heat using temperature changes without accompanying the phase change.

The latent heat storage material and the sensible heat storage material are not particularly limited, and commercially available materials can be used. Examples of the latent heat storage material include metal-based PCMs (Phase Change Materials) such as Al-base alloys, Cu-base alloys, and Fe-base alloys, and organic PCMs such as paraffin. Furthermore, examples of the sensible heat storage material include ceramics and the like. In addition, since the latent heat storage material may flow out from the cells 33 due to the phase change, it is preferable that the honeycomb structure 30 is made of a material with a lower porosity or that an encapsulated latent heat storage material is used.

The shape of the heat storage material 40 filled in the cells 33 include, but not particularly limited to, various shapes such as powder, granule, and rod. Furthermore, when applying and fixing the heat storage material 40 to the partition walls 34 that define the cells 33, a coating composition containing the heat storage material 40 and a binder may be used.

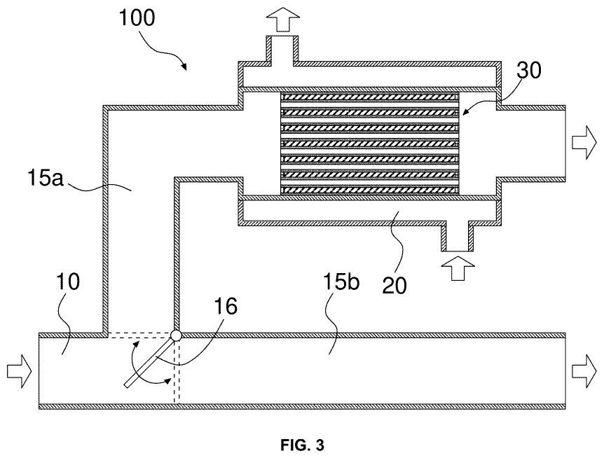

The first flow path 10 may be branched into two portions. FIG. 3 shows a cross-sectional view of the heat exchanger 100 having such a structure, which is parallel to the flow direction of the first fluid.

As shown in FIG. 3, in the heat exchanger 100, the first flow path 10 is branched into two portions, and the honeycomb structure 30 is housed in one branched first flow path 15a, and the outer peripheral side of the branched first flow path 15a is provided with a second flow path 20. Moreover, the heat exchanger 100 further includes a valve 16 capable of switching the flow of the first fluid to one branched first flow path 15a or other branched first flow path 15b.

This structure allows the valve 16 to be controlled to perform a heat recovery mode where heat recovery is performed by switching the flow of the first fluid to one branched first flow path 15a, and a non-heat recovery mode where heat recovery is not performed by switching the flow of the first fluid to the other branched first flow path 15b. In the heat recovery mode, not only heat recovery but also heat storage by the heat storage material 40 is performed. It should be noted that the valve 16 is not particularly limited, and any valve known in the art can be used.

The heat exchanger 100 can further include a control unit (not shown) capable of controlling the valve 16 to a heat recovery mode where heat recovery is performed by switching the flow of the first fluid to one branched first flow path 15a, and a non-heat recovery mode wherein heat recovery is not performed by switching the flow of the first fluid the other branched first flow path 15b. The providing of such a control unit can lead to smooth switching between the heat recovery mode and the non-heat recovery mode.

### <Second Flow Path>

The second flow path 20 is not particularly limited as long as it is capable of allowing the second fluid to flow therethrough, and has an annular flow path portion 21 extending along the axial direction of the first flow path 10 on the outer peripheral side of the first flow path 10. For example, the second flow path 20 can be configured using a second cylindrical member 22, as shown in FIG. 1A.

The second cylindrical member 22 has a feed pipe 23 capable of feeding the second fluid and a discharge pipe 24 capable of discharging the second fluid. The feed pipe 23 and the discharge pipe 24 may extend in the same direction or may extend in different directions.

The second cylindrical member 22 has a portion that is arranged with a distance on a radially outer side of the first cylindrical member 11 so as to form the second flow path 20 (annular flow path portion 21) between the second cylindrical member 22 and the first cylindrical member 11.

It is preferable that the axial direction of the second cylindrical member 22 coincides with that of the first cylindrical member 11, and the central axis of the second cylindrical member 22 coincides with that of the first cylindrical member 11.

The second cylindrical member 22 is preferably disposed such that based on the flow direction of the first fluid, the inner peripheral surface on an upstream end portion side and a downstream end portion side is in direct or indirect contact with the outer peripheral surface of the first cylindrical member 11.

The method of fixing the inner peripheral surface on the upstream end portion side and the downstream end portion side of the second cylindrical member 22 to the outer peripheral surface of the first cylindrical member 11 includes, but not particularly limited to, fixing methods based on fitting such as clearance fitting, interference fitting and shrinkage fitting, as well as brazing, welding, diffusion bonding, and the like.

The shape of the second cylindrical member 22 includes, but not particularly limited to, various cylindrical shapes such as a cylindrical shape and a rectangular cylindrical shape.

The diameter (outer diameter and inner diameter) of the second cylindrical member 22 may be uniform in the axial direction, but at least part (for example, the axial central portion, both axial end portions, or the like) is decreased or increased. For example, by decreasing the diameter of the central portion in the axial direction of the second cylindrical member 22, the second fluid can be spread throughout the outer peripheral direction of the first cylindrical member 11 in the second cylindrical member 22 on the sides of the feed pipe 23 and the discharge pipe 24. Therefore, since an amount of the second fluid that does not contribute to heat exchange is reduced in the axially central portion, the heat exchange efficiency can be improved.

It should be noted that when the second cylindrical member 22 is not cylindrical, the outer diameter and inner diameter of the second cylindrical member 22 mean the diameter of the largest circle that is circumscribed and inscribed in the cross-sectional shape of the second cylindrical member 22 perpendicular to the flow direction of the first fluid.

The material for the second cylindrical member 22 is not particularly limited, and the same material as that of the first cylindrical member 11 can be used. Further, the thickness of the second cylindrical member 22 is not particularly limited, and it may be approximately the same as the thickness of the first cylindrical member 11.

### <First Fluid and Second Fluid>

The first fluid and the second fluid used in the heat exchanger 100 are not particularly limited, and various liquids and gases can be used. For example, when the heat exchanger 100 is mounted on a motor vehicle, an exhaust gas can be used as the first fluid, and water or engine antifreeze coolants (LLC defined by JIS K2234: 2006) can be used as the second fluid. Further, the first fluid can be a fluid having a temperature higher than that of the second fluid.

### <Method for Producing Heat Exchanger>

The heat exchanger 100 can be produced in accordance with a method known in the art. For example, the heat exchanger 100 can be produced in accordance with the method as described below.

First, a green body containing ceramic powder is extruded into a desired shape to prepare a honeycomb formed body. At this time, the shape and density of the cells 33, and lengths and thicknesses of the outer peripheral wall 31 and the partition walls 34, and the like, can be controlled by selecting dies and jigs in appropriate forms. The material of the honeycomb formed body that can be used herein includes the ceramics as described above. For example, when producing a honeycomb formed body containing the Si-impregnated SiC composite as a main component, a binder and water or an organic solvent are added to a predetermined amount of SiC powder, and the resulting mixture is kneaded to form a green body, which can be then formed into a honeycomb formed body having a desired shape. The resulting honeycomb formed body can be then dried, and the honeycomb formed body can be impregnated with metal Si and fired in an inert gas reduced pressure or in a vacuum to obtain a honeycomb structure 30 having the cells 33 defined by the partition walls 34. Examples of the method for firing metal Si with impregnation include a method in which a lump containing metal Si and the honeycomb formed body are placed in contact with each other and then fired.

The heat storage material 40 is then retained in some cells 33 of the honeycomb structure 30. As the retaining method, the method described above can be used. Further, when filling some of the cells 33 of the honeycomb structure 30 with the heat storage material 40, the plugged portions 36 are formed at one end portion of the cells 33, and the heat storage material 40 is then filled from the other end portion to form the plugged portions 36 at the other end portion.

The honeycomb structure 30 that has retained the heat storage material 40 is inserted into a predetermined position of the first cylindrical member 11, and the first cylindrical member 11 is fitted into the outer peripheral wall 31 of the honeycomb structure 30. The second cylindrical member 22 is then disposed and fixed on the radially outer side of the first cylindrical member 11. It should be noted that the feed pipe 23 and the discharge pipe 24 may be fixed to the second cylindrical member 22 in advance, or may be fixed to the second cylindrical member 22 at an appropriate stage.

In addition, the arranging and fixing (fitting) orders of the respective members are not limited to the above orders, and they may be changed as needed within a range in which the members can be produced. As the fixing (fitting) method, the above method may be used.

### Embodiment 2

A heat exchanger according to Embodiment 2 of the present invention is different from the heat exchanger 100 according to Embodiment 1 of the present invention in that the former employs a hollow honeycomb structure.

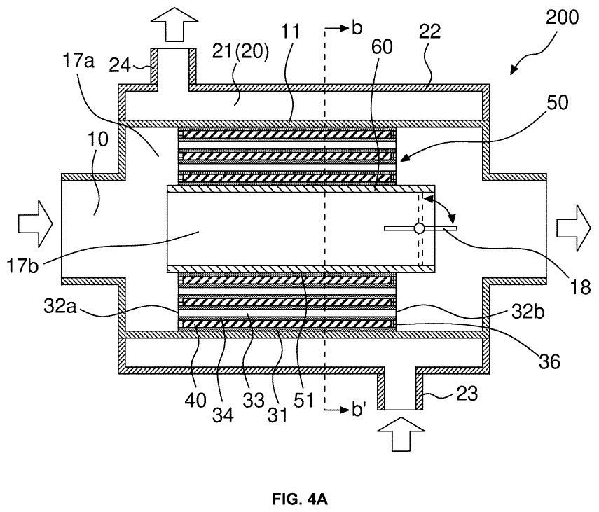

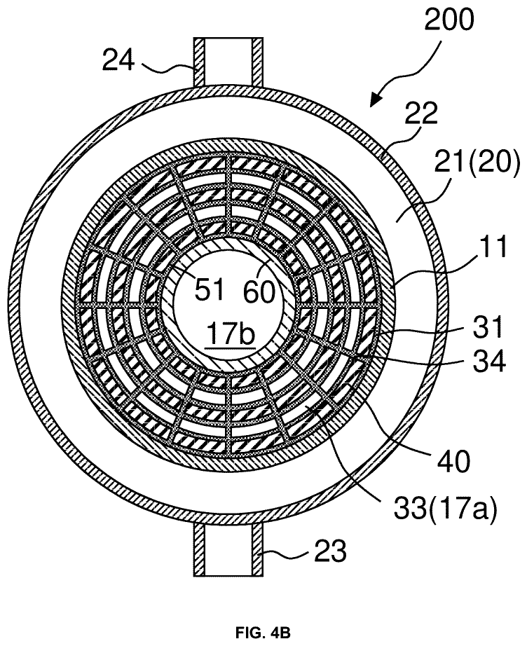

FIG. 4A is a cross-sectional view of a heat exchanger according to Embodiment 2 of the present invention, which is parallel to a flow direction of a first fluid. FIG. 4B is a cross-sectional view of the heat exchanger in FIG. 4A taken along the line b-b′.

In addition, since the components having the same reference numerals as those appearing in the descriptions of the heat exchanger 100 according to Embodiment 1 of the present invention are the same as the components of the heat exchanger 200 according to Embodiment 2 of the present invention, the descriptions of those components will be omitted.

As shown in FIGS. 4A and 4B, a heat exchanger 200 according to Embodiment 2 of the present invention includes: a first flow path 10 through which a first fluid can flow; and a second flow path 20 through which a second fluid can flow, the second flow path 20 having an annular flow path portion 21 extending along an axial direction of the first flow path 10 on an outer peripheral side of the first flow path 10. A hollow honeycomb structure 50 is housed in the first flow path 10.

The hollow honeycomb structure 50 is different from the honeycomb structure 30 in that the former further includes an inner peripheral wall 51. That is, the hollow honeycomb structure 50 includes: an outer peripheral wall 31; an inner peripheral wall 51; and partition walls 34 defining a plurality of cells 33 disposed between the inner peripheral wall 51 and the outer peripheral wall 31 and extending from a first end face 32a to a second end face 32b. A heat storage material 40 is retained in some cells 33 of the hollow honeycomb structure 50.

By using the hollow honeycomb structure 50, the heat exchanger 200 can be made more compact than the heat exchanger 100.

The thickness of the inner peripheral wall 51 is not particularly limited, and it may be substantially the same as that of the outer peripheral wall 31.

The shape of the interior of the inner peripheral wall 51 is not particularly limited, and it may be circular, elliptical, triangular, quadrilateral, hexagonal, or other polygonal in a cross section perpendicular to an extending direction of the cells 33.

The hollow honeycomb structure 50 can be produced by selecting an appropriate die and jig when producing the honeycomb formed body.

The first flow path 10 is configured to include: a first circulation route 17a in which the first fluid can flow through the cells 33 of the hollow honeycomb structure 50; and a second circulation route 17b in which the first fluid can flow through the interior of the inner peripheral wall 51 of the hollow honeycomb structure 50. Further, the first flow path 10 having such a structure may be configured using the first cylindrical member 11 and a third cylindrical member 60, for example, as shown in FIGS. 4A and 4B, although not particularly limited thereto.

Furthermore, it further includes a valve 18 capable of switching the flow of the first fluid to the first circulation route 17a or the second circulation route 17b by controlling the flow of the first fluid in the second circulation route 17b. The valve 18 may be placed at a downstream end portion of the third cylindrical member 60, for example, as shown in FIG. 4A.

The above structure allows the valve 18 to be controlled to perform a heat recovery mode where heat recovery is performed by switching the flow of the first fluid to the first circulation route 17a, and a non-heat recovery mode where heat recovery is not performed by switching the flow of the first fluid to the second circulation route 17b. In the heat recovery mode, not only heat recovery but also heat storage by the heat storage material 40 is performed. It should be noted that the valve 18 is not particularly limited, and any valve known in the art can be used.

The heat exchanger 200 can further include a control unit (not shown) that can control the valve 18 to a heat recovery mode where heat recovery is performed by switching the flow of the first fluid to the first circulation route 17a, and a non-heat recovery mode where heat recovery is not performed by switching the flow of the first fluid to the second circulation route 17b. The providing of such a control unit can lead to smooth switching between the heat recovery mode and the non-heat recovery mode.

The third cylindrical member 60 is fitted, for example, to the inner peripheral surface (the surface of the inner peripheral wall 51) of the hollow honeycomb structure 50 parallel to the flow direction of the first fluid.

The shape of the third cylindrical member 60 may be appropriately selected depending on the shape of the inner peripheral surface of the hollow honeycomb structure 50, and may be various shapes such as a cylindrical shape and a rectangular cylindrical shape.

The axial direction of the third cylindrical member 60 preferably coincides with that of the hollow honeycomb structure 50, and the central axis of the third cylindrical member 60 preferably coincides with that of the hollow honeycomb structure 50. Further, the diameter (outer diameter and inner diameter) of the third cylindrical member 60 may be uniform in the axial direction, but at least part thereof may be decreased or increased.

It should be noted that when the third cylindrical member 60 is not cylindrical, the outer diameter and inner diameter of the third cylindrical member 60 means the diameter of the larges circle that is circumscribed and inscribed in the cross-sectional shape of the third cylindrical member 60 perpendicular to the flow direction of the first fluid.

The material for the third cylindrical member 60 is not particularly limited, and the same material as that of the first cylindrical member 11 may be used. Further, the thickness of the third cylindrical member 60 is not particularly limited, and it may be approximately the same as the thickness of the first cylindrical member 11.

The heat exchanger 200 can be produced according to a method known in the art. For example, the heat exchanger 200 can be produced according to the method for producing the heat exchanger 100 as described above, with the exception that the third cylindrical member 60 is inserted into the inner peripheral wall 51 of the hollow honeycomb structure 50 retaining the heat storage material 40, and the third cylindrical member 60 is fitted to the inner peripheral wall 51 of the hollow honeycomb structure 50.

### DESCRIPTION OF REFERENCE NUMERALS

10 first flow path
11 first cylindrical member
15a one branched first flow path
15b other branched first flow path
16, 18 valve
17a first circulation route
17b second circulation route
20 second flow path
21 annular flow path portion
22 second cylindrical member
23 feed pipe
24 discharge pipe
30 honeycomb structure
31 outer peripheral wall
32a first end face
32b second end face
33 cell
34 partition wall
34a first partition wall
34b second partition wall
36 plugged portion
40 heat storage material
50 hollow honeycomb structure
51 inner peripheral wall
100, 200 heat exchanger

1. A heat exchanger comprising:
a first flow path through which a first fluid can flow; and
a second flow path through which a second fluid can flow, the second flow path having an annular flow path portion extending along an axial direction of the first flow path on an outer peripheral side of the first flow path;
wherein a honeycomb structure having an outer peripheral wall and partition walls disposed on an inner side of the outer peripheral wall, the partition walls defining a plurality of cells each extending from a first end face to a second end face, is housed in the first flow path, and
wherein a heat storage material is retained in some of the cells of the honeycomb structure.

2. The heat exchanger according to claim 1, wherein the heat storage material is filled in the cells.

3. The heat exchanger according to claim 2, wherein the cells filled with the heat storage material are plugged on the first end face side and the second end face side.

4. The heat exchanger according to claim 1, wherein a ratio of the cells having the retained heat storage material to all the cells of the honeycomb structure is 10% or more.

5. The heat exchanger according to claim 1, wherein the heat storage material is a latent heat storage material and/or a sensible heat storage material.

6. The heat exchanger according to claim 1, wherein the honeycomb structure further comprises an inner peripheral wall, and the honeycomb structure is a hollow honeycomb structure having the partition walls between the inner peripheral wall and the outer peripheral wall.

7. The heat exchanger according to claim 1,
wherein the first flow path is branched into two portions;
wherein the honeycomb structure is housed in one branched first flow path, and the second flow path is provided on an outer peripheral side of the one branched first flow path,
wherein the heat exchanger further comprises a valve capable of switching the flow of the first fluid to the one branched first flow path or other branched first flow path.

8. The heat exchanger according to claim 7, further comprising a control unit capable of controlling the valve to a heat recovery mode where heat recovery is performed by switching the flow of the first fluid to the one branched first flow path, and a non-heat recovery mode where heat recovery is not performed by switching the flow of the first fluid to the other branched first flow path.

9. The heat exchanger according to claim 6,
wherein the first flow path is configured to have a first circulation route in which the first fluid can flow through the cells of the honeycomb structure, and a second circulation route in which the first fluid can flow through the interior of the inner peripheral wall of the honeycomb structure,
wherein the heat exchanger further comprises a valve capable of switching the flow of the first fluid to the first circulation route or the second circulation route by controlling the flow of the first fluid in the second circulation route.

10. The heat exchanger according to 9, further comprising a control unit capable of controlling the valve to a heat recovery mode where heat recovery is performed by switching the flow of the first fluid to the first circulation route; and a non-heat recovery mode where heat recovery is not performed by switching the flow of the first fluid to the second circulation route.
